(19) United States
(12) Patent Application Publication
(10) Pub. No.: US 2009/0325822 A1
(43) Pub. Date: Dec. 31, 2009

(54) Apparatus For Increasing The Reaction Efficiency, Especially The Binding Efficiency, Between Molecules And Molecular Moieties

(75) Inventors: Rudolf Heer, Wien (AT); Christa Noehammer, Wien (AT); Joerg Schotter, Wien (AT); Moritz Eggeling, Melle (DE); Rudolf Pichler, Wampersdorf (AT); Markus Mansfeld, Wien (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Austrian Research Centers GmbH - ARC, Wien (AT); tecnet capital Technologiemanagement GmbH, St. Poelten (AT)

(21) Appl. No.: 12/296,524

(22) PCT Filed: Apr. 11, 2007
(86) PCT No.: PCT/AT07/00160

§ 371 Date: Aug. 21, 2009

(30) Foreign Application Priority Data
Apr. 13, 2006 (AT) A 648/2006

(51) Int. Cl. C40B 60/00

(52) U.S. Cl. 506/33

(57) ABSTRACT

An apparatus for enhancing the contact frequency between two reactants capable of binding to one another, preferably between an analyzer molecule and an analyte molecule, especially for enhancing the binding effectiveness in bioanalysis arrays with the aid of micro- or nanomagnetic particles (75) set in motion in a controlled manner in the fluid reaction medium by means of magnetic fields generated by variably feedable electromagnets (3, 2, 20) arranged on both sides of the reaction fluid film. On one side of a reaction fluid film, especially of a microscope slide (4) comprising the reactants (63), the reaction liquid (70) comprising the reactants (73) and preferably a glass plate (5) covering the microbioanalysis array (6), is arranged close to a two-dimensional matrix (20) having a multitude of miniature or millimagnetic coils (2) feedable individually with magnetization current of variable strength and/or voltage as a function of time—corresponding to a time-dependent variable magnetization pattern desired in each case—and, on the other side of the reaction vessel, especially the microscope slide (4) with the (micro)bioanalysis array (6), in whose vicinity is positioned only one magnetic coil (3) likewise feedable with variable magnetization current and whose magnetic field permeates the entire reaction vessel, especially the microbioanalysis array (6).

### CROSS-REFERENCES TO RELATED APPLICATIONS

This application claims the priorities of Austrian Patent Application No. A648/2006 filed Apr. 13, 2006 and of International Application No. PCT/AT2007/000160 filed Apr. 11, 2007, the disclosures of which are incorporated herein by reference.

### FIELD OF THE INVENTION

The present invention relates to increasing the hits or hit probability between bondable reaction partners which increases the number of bondable reaction partners or products while significantly shortening the reaction time.

### BACKGROUND OF THE INVENTION

The present invention is particularly directed toward shortening the required hybridization times in bioanalysis arrays, such as in DNA/RNA, protein or immunomicroarrays, while at the same time increasing the available fluorescence signals. This is achieved by agitating the hybridization solution with magnetic micro- or nanoparticles, which are moved in controlled manner through the hybridization solution to transport the target molecules to individual spots, i.e. bonding sites. This significantly increases and/or widens the effective range of the individual spots, which is diffusion-limited in conventional analysis methods.

The invention has the additional advantage that it can be readily combined with already existing bioanalysis array systems so that already existing reaction systems, particularly already existing bioanalysis systems, can be retrofitted.

New tools in molecular biology, such as DNA microarrays, for example, represent a true technology jump for the detection of genes and gene defects, gene expression analyses and acquiring a better understanding of gene functions.

A microbioarray or biochip conventionally has a chemically coated glass slide that contains up to a few thousand, microscopically small and differently functionalized points, so-called spots. In the case of DNA microarrays or chips, each individual spot consists of numerous copies of a clearly defined DNA section or gene. They function as “scavenger molecules” or probes for corresponding specific DNA or mRNA molecules, i.e. targets, that are present in the sample being analyzed. The target molecules are marked beforehand with fluorescence particles so that they can be detected with a fluorescence scanner after bonding of the corresponding chip probes.

Specificity and sensitivity play an important role in bio- and microarray analyses. Specificity essentially depends on the choice and sequence of DNA probes on the chip and the conditions under which the docking process or hybridization between targets and probes proceeds, such as, for example, the salt concentration of the hybridization buffer and the reaction temperature. Sensitivity essentially depends on the available amount of the corresponding target, the efficiency with which the target is fluorescence marked, and to a certain degree on the amount of DNA probe on the chip and the efficiency of the bond between the target and probe.

In conventional chip experiments, the transport of targets to the probes is controlled in an aqueous medium merely by diffusion. In practice an aqueous buffer solution with fluorescence-marked target molecules is applied to the chip with the DNA probes and a thin glass plate or cover glass is placed over it. A thin liquid film is thereby formed between the chip and cover glass, within which the target molecules move by free diffusion.

Up to now, different attempts have been made to increase the evaluable signals in DNA microarrays with different mixing or pumping devices, which can be divided into the following three categories:

Mechanical mixing by shaking or rotation of the chip on a device provided for this;

Pumping and recirculation of the hybridization solution on the chip by means of an external fluidic system; and

Mixing of the liquid on the chip itself.

Examples of the mentioned methods pursuant to the prior art are described below in order to better demonstrate the distinguishing features relative to the present invention.

Surface acoustic waves or acoustic surface waves are used by commercially available products which are available under the name “SlideBooster” from Advalytix AG, Eugen-Sänger-Strasse 53.0, D-85649 Brunnthal, www.advalytix.de, SlideBooster SB400, for mixing thin liquid films.

Active mixing of liquids was presented by R. H. Liu (R. H. Liu et al., Bubble-induced acoustic micromixing, Lab Chip, 2002, 2, 151-157). For implementing the mixing effect, acoustic microflows induced by small bubbles are used. They are preferably generated with a piezoelectric sound emitter. To increase the efficiency, microscopically small, mechanically produced pockets are incorporated in the mixing chamber, where gas bubbles form. This modification of the mixing chamber entails a considerable additional cost for producing biochips and its re-use is questionable due to contamination.

WO 94/28396 discloses a mixing device for biosensors in which the sample is homogenized with an agitator that generates mechanical waves from the outside in a chamber. The agitator produces movement in alternating directions normal to the surface of the sensor while the signals are measured.

Another patent, GB 876 070, generally describes the mixing of liquids with rotating grates.

WO 00/09991 A1 describes mixing a liquid being investigated near a border surface thereof. Here mixing occurs by moving magnetic spheres or by moving meshes. In the first case, the magnetic spheres are alternatingly pulled up and down in a liquid between two electromagnets.

Mixing of thin liquid layers that include a suspension of moving magnetic particles is described in EP 0 240 862 A1. The disclosed device also includes magnetic systems. This arrangement provides a gap for accommodating the liquid film with the permanent magnetic particles.

In another patent, WO 97/02357 A1, a mixing device for use with DNA chips is considered. Acoustic and magnetic mixing are mentioned and produced by alternating currents in electromagnets.

An electromagnetic chip or biochip is known from U.S. Pat. No. 6,806,050 B2. It employs a matrix of individually feedable microelectromagnetic units on the surface of which probe molecules are immobilized. Magnet units move molecules bonded to small magnetic particles essentially in the plane of the biochip to increase the number of bonds that is achieved.

### SUMMARY OF THE INVENTION

The device of the present invention seeks to increase the effectiveness of the individual bonding sites such as, for example, DNA spots, by adding magnetic micro- or nanoparticles to the hybridization solution. The particles are moved by an externally generated magnetic field which, for example, guides the DNA targets to the probes of the individual spots in much more targeted manner. The DNA targets are moved by or with the magnetic particle or particles in a microflow and are transported in this manner.

It is an object of the present invention to provide a device that increases the contact rate or frequency between two reaction partners capable of bonding with each other. The contacts are preferably between an analyzer molecule, or a part of such a molecule, and an analyte molecule, or part of such a molecule, to increase bonding effectiveness and to reduce the bonding times required for detection in bioanalysis arrays according to the preamble of claim 1. The device has the features mentioned in the characterizing portion of this claim.

In particular, the combination of a matrix-like arrangement of micro- or millimagnetic coils with only one opposite central magnetic coil permits a targeted and accurate movement of the magnetic particles in the reaction liquid, especially a hybridization liquid film for the controlled guiding of target DNA to the immobilized probes on the DNA biochip.

The special arrangement of micro- or millicoils, and the “pattern” for feeding the magnetizing current to them, prevent an accumulation of magnetic particles and therefore represent a significant advantage relative to the known mixing devices mentioned above that move magnetic particles. The use of magnetic fields further facilitates a simple combination with a sample chamber in which moisture and temperature are controlled which makes a higher degree of system integration possible.

The matrix-like or array-like arrangement of the millimagnetic coils with or without magnetic cores that are located, for example, beneath the DNA chip, and the use of only one magnetic coil above the DNA chip enable a very targeted movement of the magnetic particles.

The individual magnetic coil above the chip causes the magnetic particles to move in an upward direction. When this coil is no longer magnetic because the current has been switched off, the magnetic particles begin to descend again. Descent along the same path as the rising path is prevented by magnetizing the micromagnetic coils of the micromagnetic matrix beneath the chip, for example, in a wave-like manner. The magnetic particles are therefore shifted sideways during their descent and ultimately an oblique flow is induced in the reaction liquid. This enhances the movement of the target molecules so that more probe molecules are supplied as well.

The present invention therefore moves the particles laterally towards the center of the appropriately switched micromagnetic matrix. By varying the duration and relative intensity of the pulses of adjacent micromagnetic coils and the magnetic coil arranged above the chip, any desired movement pattern can be programmed for a targeted lateral and vertical transport of the target molecules dissolved in the hybridization liquid film.

In contrast to the earlier discussed prior art arrangements, which deal with undirected or, at most, with a one-directional mixing of liquid films, the arrangement of the present invention permits a pre-programmed and very targeted movement of the micromagnetic particles. In contrast to the prior art, the device of the present invention prevents the agglomeration and/or collection of magnetic particles in particular.

The present invention further provides the advantage that it can be readily combined with existing bioanalysis arrays. In addition, by integrating the magnetic coil on a support, the temperature at the interface to the biochip can be precisely set with an integrated cooling/heating loop as is further discussed below.

The device of the present invention therefore differs from arrangements that exclusively employ process steps in an integrated microfluidic biochip, which cannot be used for retrofitting existing DNA microarrays.

To demonstrate the effectiveness of the device of the present invention, hybridization experiments were conducted on equivalent DNA biochips with the device of the present invention and, parallel thereto, in the conventional manner. Constant temperature conditions (65° C.), hybridization times (25 minutes) and evaluation methods were maintained in the experiments. When using the device of the present invention over all experiments, an average signal gain of about 150%

$$( signal gain = ( \frac{( Device signal - Reference signal )}{Reference signal} ) \cdot 100 )$$

was obtained over all experiments relative to what is attainable with conventional hybridization.

An advantageous variant embodiment of the invention provides a control device for the micromagnetic coils, on the one hand, and for the individual magnetic coil, on the other hand, in accordance with claim 2, by means of which each micromagnetic coil can be controlled individually and by means of which each time-dependent magnetization pattern can be impressed on the magnetic matrix surface.

In another embodiment for an interference-free optical control, the individual magnetic coil of the device without a core, i.e. with an exposed center recess according to claim 3, provides a clear view of the reaction event, especially on the bioanalysis chip or array.

The characterizing features of claim 4 can be used to increase the effectiveness of the arrangement of the micromagnetic coils of the magnet coil matrix.

Moreover arranging the analysis device in a climatized chamber according to claim 5 is also preferred, especially when stable environmental conditions must be precisely maintained.

claim 6 concerns a specific arrangement of the components of the device of the present invention.

Finally, claim 7 is directed to a preferred embodiment of the device that has a receiving chamber for the reaction vessel, which is particularly useful for the bioanalysis array microchip.

### BRIEF DESCRIPTION OF THE DRAWINGS

FIG. 1 shows the basic arrangement of the essential components of the device of the present invention;

FIG. 2 schematically depicts the processes during magnetization on the slide;

FIG. 3 schematically shows the control of the new device;

FIG. 4 shows an example of a real variant of the new device;

FIG. 5 schematically depicts a diagram of the path covered by a magnetic particle within the sample liquid;

FIG. 6a shows the signal increase during use of the new device in comparison; and

FIG. 6b is a diagram which shows the signal increase as a function of hybridization time and also in comparison with the prior art.

### DETAILED DESCRIPTION OF THE INVENTION

The perspective view of FIG. 1 shows the essential structure of a device 1 made according to the present invention for a magnetically-induced intensification of contacts between two reaction partners, especially bonding partners, such as, for example, target molecules and probe molecules.

A bioanalysis array 6 with regularly applied small spots of respective probe molecules or biochips 6 is arranged on a glass slide 4 beneath a cover glass 5. The reaction liquid, especially a hybridization liquid with the target molecules, and the micromagnetic particles provided for agitation of the liquid are situated between slide 4 and cover glass 5.

FIG. 1 shows above this arrangement a flat-ring-like or toroid-shaped individual magnetic coil 3 without core, i.e. with an unobstructed central opening 36, that exposes and permits viewing of the reaction on slide 4 or beneath cover glass 5.

A large number of micromagnetic coils 2 that have coil cores 21 are individually supplied with a magnetization current. The coils 2 are preferably arranged in a hexagonal matrix 20 beneath and in the vicinity of biochip 6 beneath slide 4.

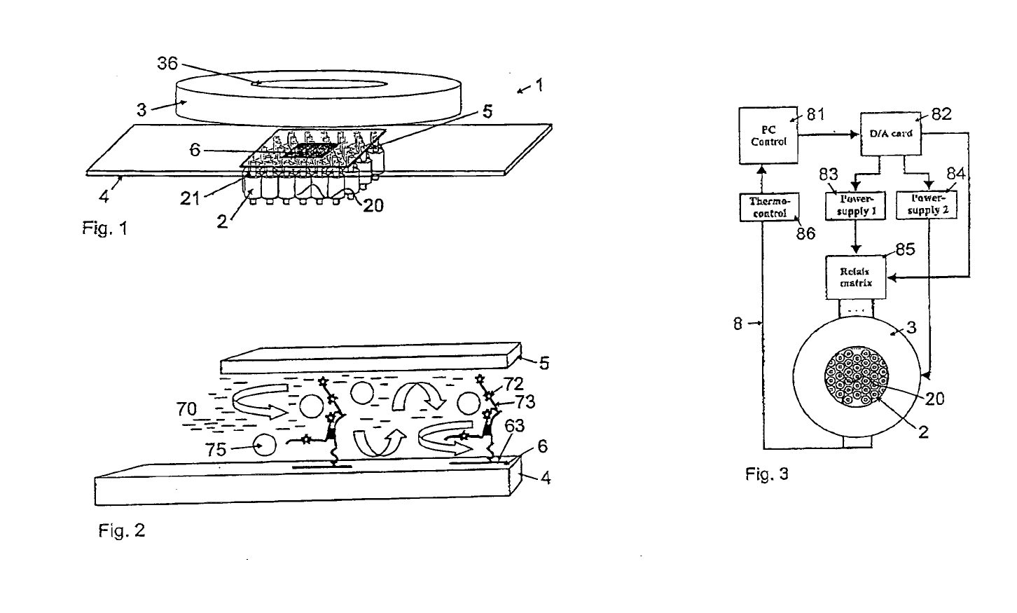

The schematic of FIG. 2 shows (with otherwise constant equivalent designations) how the reaction liquid 70 is situated between slide 4 having spots with probe molecules 63 of the biochip 6 and magnetic particles 75 (shown here as circles), and how they are moved in the movement direction indicated by the arrows while acted upon by the previously explained electromagnets 2 or 20, 3 and their variable magnetic fields to bring target molecules 73 exposed to fluorescence dye 72 (shown as small asterisks) into contact with the stationary probe molecules 63 where they bond at much greater frequency than would be attainable, for example, by diffusion.

A control device 8 schematically shown in FIG. 3 (with otherwise constant equivalent designations) serves to individually supply micromagnetic coils 2 of micromagnetic matrix 20 with variable magnetization currents and for also variably supplying the individual magnetic coil 3 with current.

A central control unit (PC control) 81 is connected to a control device, for example a D/A card 82, which is connected, on the one hand, to a power supply 83 (power supply 1) for micromagnetic coil matrix 20 and, on the other hand, to a power supply 84 (power supply 2) for the individual magnetic coil 3.

Power supply 83 (power supply 1) is connected to a relay matrix unit 85 that is itself directly connected to D/A card 82. The D/A card in turn individually supplies power, which is variable as a function of time, to each individual micromagnetic coil 2 of magnetic matrix 20 connected to it in accordance with a program provided by central control unit 81.

The probe includes a temperature control. For this, a temperature control unit (thermocontrol) 86 is directly connected to the central control unit 81 and supplies the control unit with actual temperature data from thermosensors (not shown here) arranged in the probe area or in the vicinity of the magnets 2, 20 and 3.

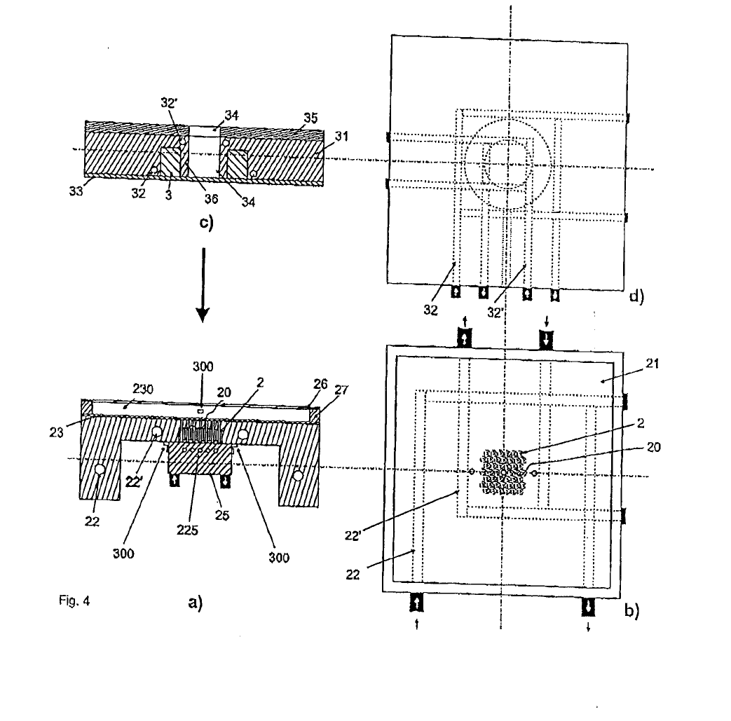

FIG. 4 shows (with otherwise constant equivalent designations) in sectional views from the side and top the actual configuration of the components of the new and improved analysis device 1 of the present invention. A slide (not shown in FIG. 4) for the reaction that is to be performed is arranged between a cover unit II and a base unit I.

As is apparent from FIG. 4a, base unit I includes an aluminum block 21 that is traversed by cooling/heating medium channels 22, 22′. Magnetic coil matrix 20 with the micromagnetic coils 2 is arranged at a mid-portion thereof. Another, smaller aluminum block 25, also traversed by a cooling and heating medium channel 225, is arranged beneath matrix 20.

FIG. 4b illustrates the arrangement and orientation of the cooling/heating medium channels 22, 22′. Their intakes and discharges are indicated by arrows. Openings generated during the production of the channels in the block 21 are closed with plugs or stoppers.

The top of aluminum block 21 is covered with a thin film 23. Rubber rings or loops 26, 27 are arranged around the periphery of the block, the inside of which forms a space 230 for placing the sample.

Cover unit II shown in FIG. 4c includes an aluminum block 31 bounded on the top by a stainless steel cover surface 35 that has a recess 34 at its mid-portion. Block 31 is also traversed by cooling/heating medium channels 32 and houses the annular individual magnetic coil 3.

A center opening 34′ extends through aluminum block 31, exposes and permits viewing of the sample, and is sealed on the bottom with a glass plate 33.

Temperature control occurs by means of thermocouples 300 which send current temperature data to the previously mentioned thermocontrol unit.

FIG. 4d provides a top view of the arrangement and orientation of the cooling/heating medium channels 32 in aluminum block 31 of cover unit II.

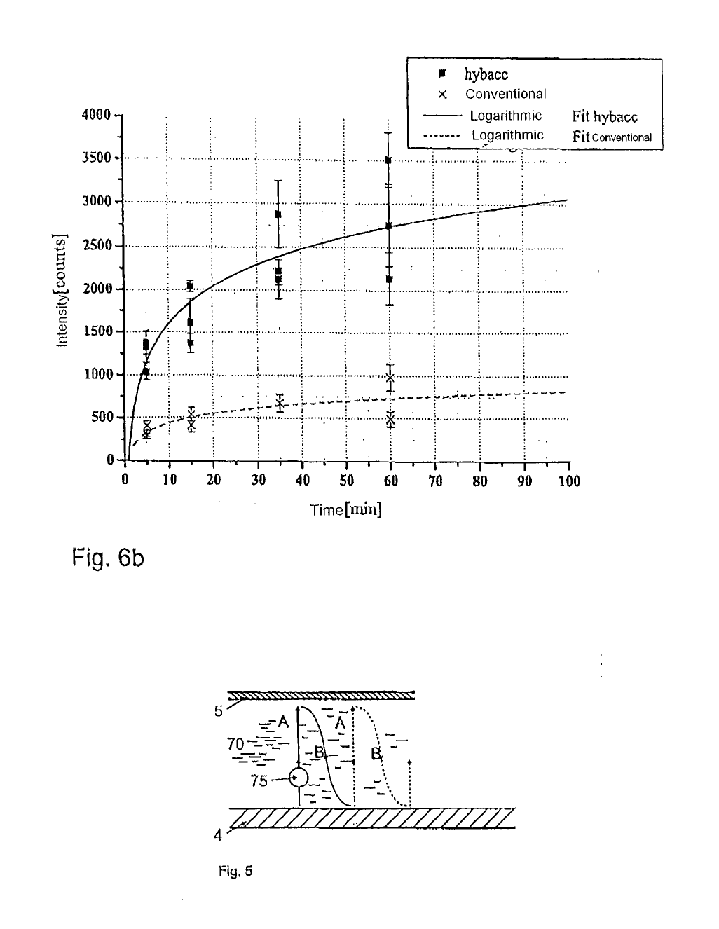

FIG. 5 schematically shows (with otherwise constant equivalent designations) the path and movement direction of micromagnetic particles 75 in liquid film 70 between slide 4 or biochip 6 and cover glass 5. Upon activation of the upper individual magnetic coil 3, an individual magnetic particle 75 is pulled upward approximately vertically along path A. During descent after the individual magnetic coil 3 has been turned off, the magnetic particle 75 is deflected laterally by the magnetic field of a magnetized micromagnetic coil 2 lying just outside the rising path A, so that the particle then follows approximately path B.

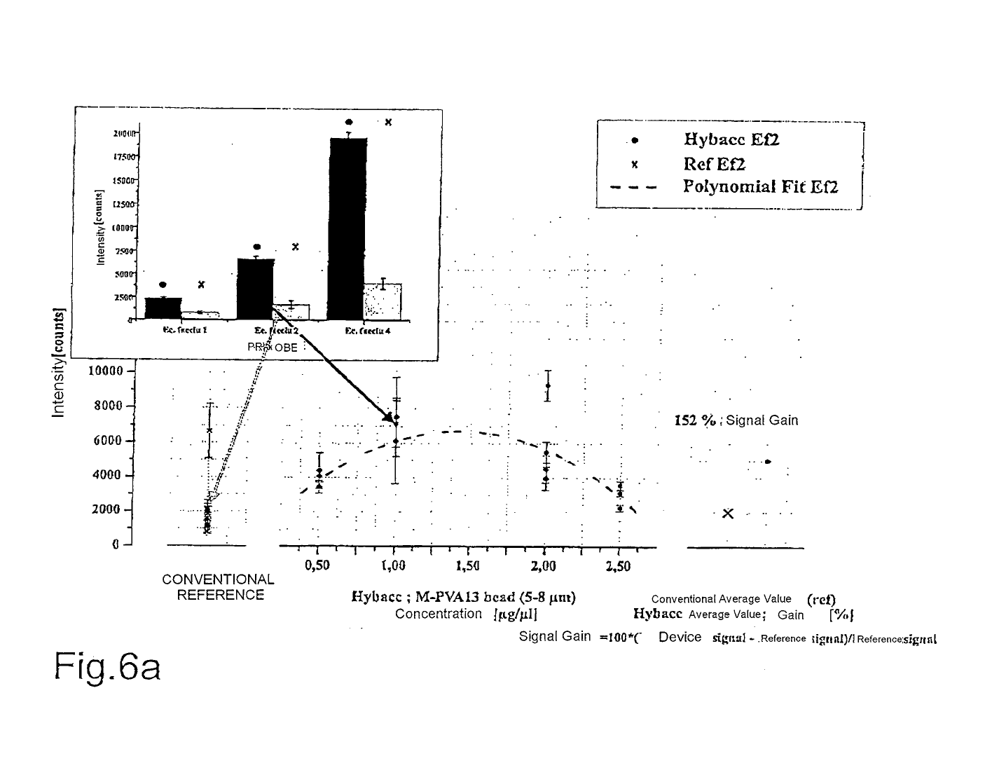

FIGS. 6a and 6b show signal increases achieved with the device of the present invention as a function of the concentration of magnetic particles after hybridization.

The ordinate of the diagram of FIG. 6a is the intensity of fluorescence indication, and the abscissa shows the concentration of magnetic particles M-PVA 13 beads (5-8 μm) (Chemagen AG, Arnold-Sommerfeld-Ring 2, D-52499 Baesweiler) are plotted in μg/μL.

The signal values shown in square form were achieved with the above-described device; those depicted with crosses were achieved conventionally. It shows a higher average signal gain. The reference signals of the DNA probe of Ec. faecium 2 are shown in FIG. 6a as a small cross at the bottom of the left column. The corresponding average value is marked as a small red cross in the right column. The signals of the probe Ec. faecium 2 generated during use of the new device are shown in the middle column for four different bead concentrations. Each of the data points shown here (small squares) corresponds to one experiment; the error bars are obtained by evaluating six replicates of the probe Ec. faecium 2 per experiment. The hybridization time in the corresponding experiments was 25 minutes.

The use of the new device for all experiments shows that the average signal gain was about 150% as compared to conventional hybridization. The signals for the DNA probe Ec. faecium 2 were arithmetically averaged for different bead concentrations.

FIG. 6b shows (with otherwise constant equivalent designations) a comparison of the intensities I of the fluorescence signals obtained with the device of the present invention to the intensities of the signals obtained in a conventional manner as a function of hybridization time.

The hybridization time is plotted on the abscissa in minutes, and the concentration of micromagnetic particles or beads M-PVA 13 bead 5-8 μm is kept constant at 1.8 μg/μL.

After only 5 minutes a very large signal gain is encountered when using the device of the present invention.
(1) Advalytix AG, Eugen-Sänger-Strasse 53.0, D-85649 Brunnthal, www.advalytix.de, SlideBooster SB400
(2) R. H. Liu et al., Bubble-induced acoustic micromixing, Lab Chip, 2002, 2, 151-157
(3) WO 94/28396
(4) GB 876,070 A
(5) WO 00/09991 A1
(6) EP 0 240 862 A1
(7) WO 97/02357 A1
(8) U.S. Pat. No. 6,806,050 B2

1. A device for increasing a contact rate or frequency between first and second reaction partners capable of bonding with each other, and preferably between analyzer molecules or parts of molecules and analyte molecules or parts of molecules, especially for increasing a bonding effectiveness and for reducing bonding times required for detection in bioanalysis-arrays, such as DNA/RNA, protein or immunomicroarrays with magnetic fields that are externally generated by electromagnets (3, 2, 20) in a contactless manner in a fluid reaction medium, especially a liquid surrounding the bioanalysis array for moving in targeted fashion para-, superpara- or ferromagnetic, spherical or irregularly shaped micro- or nanoparticles (75) that are optionally coated with one of the reaction partners, the electromagnets being adapted to be fed variable currents and arranged on both sides of a reaction volume or reaction fluid film,
characterized in that
a reaction vessel or reaction fluid film, especially an object carrier (4), is provided and a transparent cover glass (5) is arranged on a side thereof, the reaction partner (73) or partners and the reaction fluid (70) and preferably a micro bioanalyze array (6) being covered by the cover glass in an immediate vicinity of a two-dimensional surface matrix (20) or an array of a plurality of miniature and/or millimagnetic coils (2), with or without a field enhancing core (21), which can be supplied with individual magnetizing currents having pre-established, time-dependent, variable strengths and/or voltages that correspond to a desired, time-dependent, variable or changeable magnetization and/or field strength sample, and
in that only one magnetic coil (3), also adapted to be fed a variable magnetizing current, is positioned at another side of the reaction vessel, especially the object carrier (4) with the micro bioanalyze array (6), in an immediate vicinity of the object carrier and the micro bioanalyze array so that a magnetic field of the only one magnet extends through at least a portion of the reaction vessel or important parts thereof including particularly the entire micro bioanalysis array (6).

2. A device according to claim 1, including a magnet control device (8) with a central control unit (81) for supplying or feeding the only one magnetic coil (3) and each of the miniature magnetic coils (2) of the magnetic coil matrix and/or the magnetic coil array (20) individually and independently of the other miniature magnetic coils with a variable magnetization current, especially with respect to the type of current, such as DC or AC, frequency, wave shape, amplitude and/or phase shift so that, according to a selected program, a locally-variable movement of the magnetic particles (75) in all three spatial directions is induced in the desired movement direction, path and velocity in the reaction liquid of the reaction fluid film and/or in the liquid surrounding the (micro)bioanalysis array or biochip (6).

3. A device according to claim 1, characterized in that the only one magnetic coil (3) is annular and without a core to permit viewing the reaction vessel, especially of the microbioanalysis array or microbiochip (6).

4. A device according to claim 1, characterized in that the micromagnetic coils (2) of the micromagnetic coil matrix (20) have the smallest possible intermediate spaces between each other, have a circular, square or hexagonal cross-section, and are arranged in a square matrix or a honeycomb-like hexagonal matrix (20).

5. A device according to claim 1, characterized in that the device is arranged in a chamber in which a moisture of a gas surrounding the reagent vessel, especially the microbioanalysis array (6), and preferably also its temperature and optionally its pressure are controllable and adjustable.

6. A device according to claim 1,
characterized in that
the only one magnetic spool (3) is positioned in an aluminum block (31) of a good heat conducting material, especially aluminum,
in that a preferably separate fluid medium flow channel (32, 32′) is provided in the aluminum block which extends proximate to an outer surface thereof in a vicinity of the reaction vessel, especially the (micro)bioanalysis array (6) and above thereof in a proximity to an inner boundary thereof,
in that the micromagnetic coil matrix (20) is optionally arranged in an aluminum block or a table (21) and is laterally surrounded by another fluid medium flow channel (22, 22′) through which a cooling or heating fluid can flow, and
in that a cooling channel system (225) is additionally optionally arranged in a separate metal block (25) beneath the micromagnetic coil matrix (20).

7. A device according to claim 6, characterized by a glass plate (33) which seals the metal, especially aluminum, block (31) with the only one magnetic coil (3) relative to the reaction vessel, especially the bioanalysis array (6) or microbiochip, by an optional aluminum or plastic cover film (23) that closes the metal, especially aluminum, block (21) with the micromagnetic coil matrix (20), and by at least one closed rubber ring element (26, 27) arranged near an edge between the above-mentioned glass plate 33 and the cover film (23) that optionally holds the two metal, especially aluminum, blocks (21, 31) at a spacing from each other to form a sample chamber (230) that is shielded from the surroundings and its effects.
